(19) United States
(12) Patent Application Publication
(10) Pub. No.: US 2011/0199338 A1
(43) Pub. Date: Aug. 18, 2011

(54) TOUCH SCREEN APPARATUS AND METHOD FOR INPUTTING USER INFORMATION ON A SCREEN THROUGH CONTEXT AWARENESS

(76) Inventor: Hyun Kyu Kim, Seoul (KR)

(21) Appl. No.: 13/063,197

(22) PCT Filed: Aug. 11, 2009
(86) PCT No.: PCT/KR2009/004459

§ 371 Date: Mar. 9, 2011

(30) Foreign Application Priority Data
Sep. 10, 2008 (KR) 10-2008-0089340

(51) Int. Cl. G06F 3/042

(52) U.S. Cl. 345/175

(57) ABSTRACT

The present invention provides a touch screen apparatus comprising a first light emitting unit for generating an optical signal for performing non-touch sensing, a second light emitting unit for generating an optical signal for performing touch sensing together with the non-touch sensing, an optical guide unit for guiding light emitted from the second light emitting unit, and a light receiving unit for receiving light emitted and changed by an object. Further, the present invention provides a method for inputting user information on a screen through context awareness, which can input user information in an accurate and convenient manner on the screen through the awareness of a variety of user contexts, and which can effectively prevent an erroneous operation caused by a contact of the palm of the user by ignoring the contact coordinates input by a means other than the finger of the user on the screen.

### CROSS-REFERENCE TO RELATED APPLICATION

This application claims priority to and the benefit of Korean Patent Application No. 2008-0089340, filed on Sep. 10, 2008, the disclosure of which is incorporated herein by reference in its entirety.

### BACKGROUND

1. Field of the Invention

The present invention relates to a touch screen apparatus and a method for inputting user information on a screen through context awareness, and more particularly, to a touch screen apparatus and a method for inputting user information on a screen through context awareness, which can simultaneously perform touch sensing and non-touch (access) sensing, input user information more accurately and conveniently on the screen through the awareness of a variety of user contexts, and effectively prevent an erroneous operation caused by contact with a palm or the like by ignoring input contact coordinates other than those of fingers on the screen.

2. Discussion of Related Art

In order to improve the interaction between a user and a computer, displays using touch screen devices have been widely introduced into multimedia information kiosks, education centers, vending machines, video games, and the like.

A touch screen display is a display screen capable of being affected by physical contact, and enables the user to interact with the computer by touching an icon, an image, a word, or another visual object on a computer screen. In other words, physical contact with the screen in an input position is made by a general object (for example, a finger) or a pen, a stylus, or the like for preventing the screen from becoming dirty and spotted.

In related art, touch screen-related technology is disclosed in Japanese Patent Application No. 11-273293, Korean Patent Application Publication No. 2006-83420, U.S. Patent Application Publication No. 2008/0029691, and the like.

In Japanese Patent Application No. 11-273293, Korean Patent Application Publication No. 2006-83420, U.S. Patent Application No. 2008/0029691, and the like, a touch panel, a display device having a touch panel, and an electric device having a display device are disclosed. In this structure, a light guide plate is illuminated by a lighting means. A structure in which light from the lighting means is incident on two sides of the light guide plate and the incident light of the lighting means collides with an optical sensor located on a side surface or a lower surface of the light guide plate facing the lighting means is provided.

However, this structure has a disadvantage in that a certain object is recognized only by direct contact with a touch screen surface, and has a problem in that an attribute of the object making contact is not recognized when the contact is made.

If the attribute of the object making the contact is not recognized, there is a possibility that an erroneous operation is caused by recognition different from the user's intention. For example, an erroneous operation may be caused by contact with a palm, an elbow, or an object other than fingers in use.

If the attribute of the object making contact is not recognized, for example, if two contacts are made by fingers, there is a problem in that it is not possible to distinguish whether the contacts are made by two fingers of one hand or by fingers of different hands.

On the other hand, the development of computers is changing human life in various ways. As computers become widely used, their use range is gradually extending from their initial purpose of calculation to document creation, storage, searching, entertainment, gaming, and the like.

In particular, the implementation of virtual reality has obtained excellent results in games, education, and training. Through virtual reality, it is possible to cost-effectively have the same experience as an actual situation and provide efficient and safe education and training. The virtual reality is being used in various fields of seabed exploration, flight training, train driving, and the like.

This virtual reality technology has developed rapidly since the 1980s. Particularly, projection types of virtual environments using a large screen have been built and applied to many fields due to such advantages as full immersion and interactivity, which are basic functions of the virtual reality, and the realization of augmented reality through remote collaboration and an interface.

The application of the virtual reality has been made in many various fields of all sorts of design for building construction, medical engineering, automobiles, and the like, reconstruction and development of cultural content, realization of a simulated global environment, and the like. In other words, the virtual reality may virtually realize an environment which people may not easily come in contact with in their real lives. The virtual reality may adjust a complex real environment according to a level of each person and thus it is very effective in building an educational environment supplementing a real natural environment.

In fact, virtual reality environments in which various simulations can be built have recently been used for science or math education in many studies. Examples include Newton's World, which helps to easily learn Newton's physical mechanics, the Virtual Gorilla Project, which helps to teach gorilla's habits, behaviors, and habitats, the Round Earth Project, which helps to teach the concept that “the earth is round,” Virtual Ambients, which helps elementary school students learn scientific observation and exploration ability, and the Virtual Puget Sound, which helps to observe and measure how any environmental factor such as pollution, flooding, or the like may affect the ocean.

In addition, virtual cultural heritage environments that can help to restore cultural and historical sites or cultural assets to their original state and can help spectators go back to past historical eras to experience them using the virtual reality technology have been actively studied. Through the virtual reality technology, the virtual cultural heritage environments restore cultural assets that actually exist but are currently significantly damaged or realize the cultural assets of which no remains can be found. For example, the Seorabeol Project has been produced by the virtual reality technology to restore Seorabeol, the capital city of United Silla, including its major historical Buddhist sites such as Seokguram grotto, Hwangrong temple, a Buddhist image group of Namsan, and the like. It gives a feeling as if going back to the time/space of the splendid cultures of United Silla.

Various devices have recently been proposed for interfaces for use in the virtual reality as described above, that is, three-dimensional applications. It is important for the interface devices to obtain position information on a three-dimensional space. Usually, a sensor is attached to a human body and a sensor-attached tool is used. However, there is a problem in that the above-described interface devices do not secure a natural motion of a human being and learning is required before use.

### SUMMARY OF THE INVENTION

The present invention is directed to provide a touch screen apparatus capable of recognizing an object even during a non-touch operation.

The present invention is also directed to increasing touch sensitivity by providing a touch screen apparatus in which sensing is possible during both a touch and a non-touch operation.

The present invention is also directed to provide a touch screen apparatus in which multi-touch is possible.

The present invention is also directed to provide an apparatus capable of recognizing an attribute of a touch finger or object by providing a touch screen apparatus in which sensing is possible during both a touch and a non-touch operation.

The present invention is also directed to provide a method for inputting user information on a screen through context awareness, which can input user information more accurately and conveniently on the screen through the awareness of a variety of user contexts, and effectively prevent an erroneous operation caused by contact with a palm or the like by ignoring input contact coordinates other than those of fingers on the screen.

According to a first aspect of the present invention, there is provided a touch screen apparatus including: a first light-emitting section for emitting light of an optical signal to perform non-touch sensing; a second light-emitting section for emitting light of an optical signal to perform touch sensing along with the non-touch sensing; a light guide section for guiding the light emitted from the second light-emitting section; and a light-receiving section for receiving the lights emitted from the first light-emitting section and the second light-emitting section varying with an object.

The first and second light-emitting sections may be implemented to emit lights by different modulations or emit lights of different wavelengths. In both cases, the light-receiving section may be disposed in the format of a matrix to recognize X and Y coordinates. Different types of light-receiving elements or the same type of light-receiving elements may be disposed. For example, light-receiving elements for sensing the light emitted from the first light-emitting section and light-receiving elements for sensing the light emitted from the second light-emitting section may be separately disposed in the form of a matrix.

The term “non-touch” means a state in which an object accesses the touch screen apparatus without making contact with the touch screen apparatus, and is used to make a distinction from a touch.

The term “object” means a hand of a human being or a physical object available in a touch.

On the other hand, it is preferable that modulation frequencies of the light emitted from the first light-emitting section and the light emitted from the second light-emitting section not become multiples of each other. If the modulation frequencies become multiples of each other, the light-receiving section may not easily separate and recognize the modulation frequencies. If a frequency difference is large, for example, 10 kHz or more, the light-receiving section may easily separate and sense signals modulated in the first and second light-emitting sections.

The light-receiving section may be manufactured to be integrated into a video panel, integrated along with a backlight of a liquid crystal display (LCD) device, manufactured in the form of a separate panel, or separately manufactured in the form of a camera of a charge coupled device (CCD), a complementary metal-oxide semiconductor (CMOS) image sensor, or the like. That is, various methods may be adopted without particular limitation as long as a signal varying with an object is sensed from light emitted by the first and second light-emitting sections.

The light-emitting section has a structure that transfers light through a light guide, but the present invention is not limited thereto. Various methods are possible as long as an optical signal varies with a non-touch or touch operation and the varied signal is received by the light-receiving section. In a structure of the light-emitting section, the first and second light-emitting sections may be formed together on an upper edge of the touch screen apparatus. A structure in which light of the first light-emitting section is transferred through the light guide and the second light-emitting section is formed on an upper edge of the touch screen apparatus is also possible. The first and second light-emitting sections may all be formed on a lower portion of the touch screen apparatus. In this case, it is possible to uniformly transfer light in an upward direction separately from the backlight or using the same light guide plate.

According to a second aspect of the present invention, there is provided a touch screen apparatus including: first and second light-emitting sections for emitting lights of optical signals to perform non-touch sensing and touch sensing; and a light-receiving section for receiving the lights emitted from the first and second light-emitting sections varying with an object, wherein the light-receiving section separates and senses the lights emitted from the first and second light-emitting sections.

According to a third aspect of the present invention, there is provided a method for inputting user information on a screen through context awareness, including the steps of: (a) recognizing a position of a user by sensing the user accessing the screen; (b) recognizing a position of the user's hand by sensing an access state of the user located on the screen; (c) recognizing right and left hands of the user using an angle and a distance according to the position of the user and the position of the user's hand recognized in steps (a) and (b); (d) recognizing a shape and a specific motion of the user's hand by sensing a motion of the user located on the screen; (e) recognizing a type of finger of the user located on the screen using a real-time image processing method; and (f) allocating, after sensing an object making contact on the screen and recognizing coordinates of the object, a specific command for recognized contact coordinates on the basis of at least one of the left and right hands of the user, the shape and the specific motion of the user's hand, and the type of finger of the user recognized in steps (c) to (e).

In step (a), the user accessing the screen may be sensed using at least one camera or line sensor installed in all directions of the screen.

In step (a), the user accessing the screen may be sensed using radio frequency identification (RFID) communication or fingerprint recognition.

In step (b), an access state of the user located on the screen may be sensed using any one of a camera, an infrared sensor, and a capacitive method.

In step (d), a specific command may be allocated and executed on the basis of the recognized shape and specific motion of the user's hand.

In step (d), the shape and the specific motion of the user's hand located on the screen may be recognized in real time using three-dimensional (X, Y, and Z) coordinates.

In step (e), the real-time image processing method may acquire an image of the user's hand located on the screen and perform recognition by comparing the acquired hand image with various hand shape images previously stored.

In step (f), an object making contact on the screen may be sensed using any one of a camera, an infrared sensor, and a capacitive method.

According to a fourth aspect of the present invention, there is provided a method for inputting user information on a screen through context awareness, including the steps of: (a′) recognizing a shape and a specific motion of a user's hand by sensing a motion of the user located on the screen; and (b′) allocating a specific command on the basis of the recognized shape and specific motion of the user's hand.

In step (a′), the shape and the specific motion of the user's hand located on the screen may be recognized in real time using three-dimensional (X, Y, and Z) coordinates.

According to a fifth aspect of the present invention, there is provided a recording medium recording a program for executing a method for inputting user information on a screen through context awareness.

According to the present invention, a user can experience convenience since a touch screen apparatus can also recognize a non-touch operation of an object, that is, access to the touch screen apparatus, as compared with a contact type of touch screen of related art.

Also, a touch screen apparatus capable of sensing both a touch and a non-touch operation can be relatively simply and cost-effectively provided.

Also, the present invention can provide a touch screen apparatus in which both a touch and a non-touch operation can be sensed and multi-touch is also possible.

Also, the touch screen apparatus can embody an attribute of a touch object when a direct touch is performed on a screen by sensing the object accessing the screen in real time.

According to the present invention, it is possible to input user information more accurately and conveniently on the screen through the awareness of a variety of user contexts, and effectively prevent an erroneous operation caused by contact with a palm or the like by ignoring input contact coordinates other than those of fingers on the screen.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a schematic configuration diagram of a touch screen apparatus 1 according to an embodiment of the present invention;

FIG. 2 is a conceptual diagram illustrating an example of a light-receiving mode and a light-emitting mode of light-emitting sections 130 and 140 and a light-receiving section 110 applied to an embodiment of the present invention;

FIG. 3 is a detailed block diagram illustrating configurations of the light-emitting sections 130 and 140 according to an embodiment of the present invention in further detail;

FIG. 4 is a detailed block diagram illustrating a process of processing an optical signal received by a configuration of the light-receiving section 110 according to an embodiment of the present invention in further detail;

FIG. 5 is a schematic configuration diagram of a touch screen apparatus 1 according to another embodiment of the present invention;

FIG. 6 is a schematic configuration diagram of a touch screen apparatus 1 according to yet another embodiment of the present invention;

FIG. 7 is a schematic configuration diagram of a touch screen apparatus 1 according to yet another embodiment of the present invention;

FIG. 8 is a schematic configuration diagram of a touch screen apparatus 1 according to yet another embodiment of the present invention;

FIG. 9 is a schematic configuration diagram of a light-emitting section according to yet another embodiment of the present invention;

FIG. 10 is an overall flowchart illustrating a method for inputting user information on a screen through context awareness according to yet another embodiment of the present invention;

FIG. 11 is a diagram illustrating recognition of a finger shape of a user using real-time image processing applied to the method for inputting user information on the screen through context awareness according to yet another embodiment of the present invention; and

FIG. 12 is a diagram illustrating an example of a process of recognizing an object on the screen in the method for inputting user information on the screen through context awareness according to yet another embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

### Embodiments

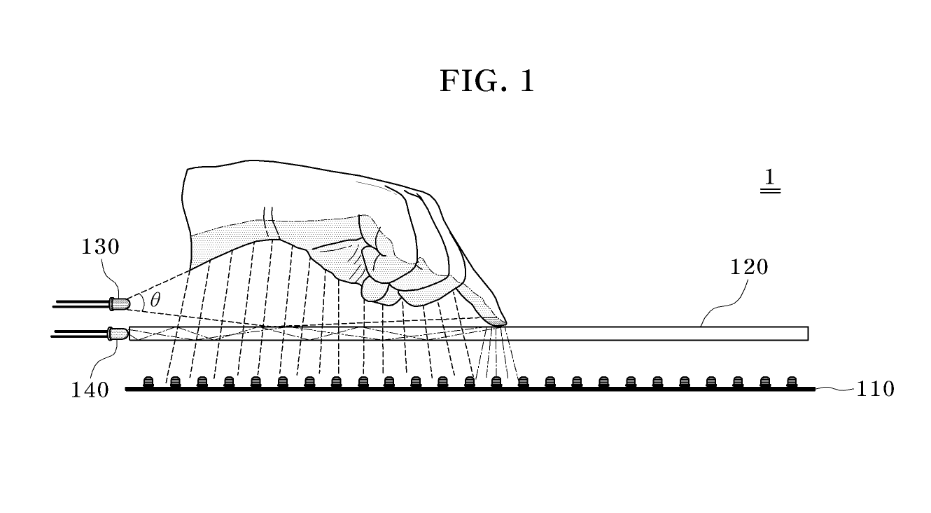

FIG. 1 is a schematic configuration diagram of a touch screen apparatus 1 according to an embodiment of the present invention.

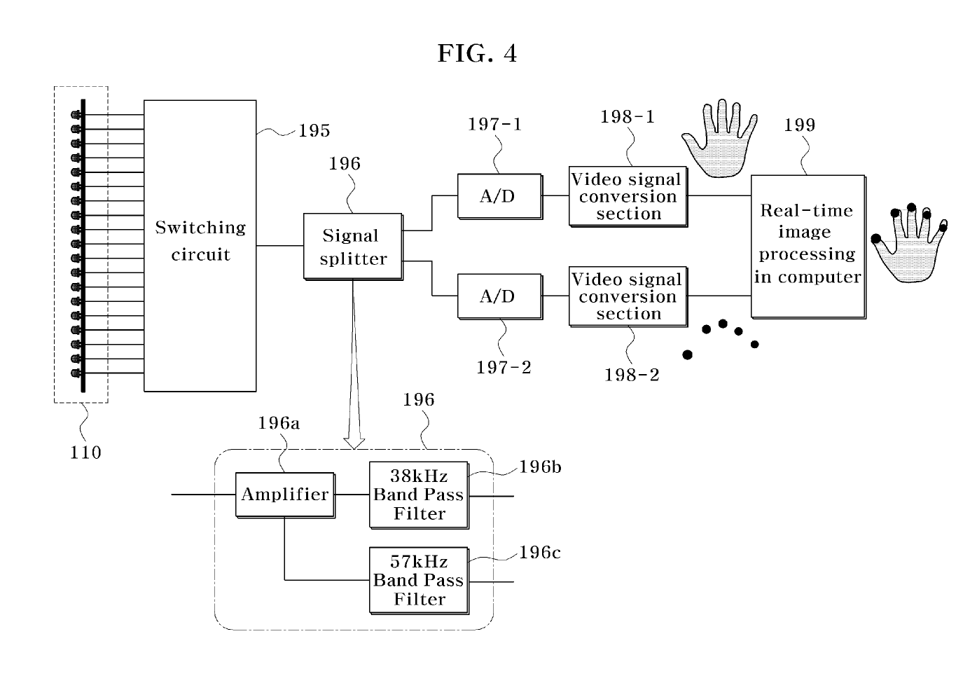

Referring to FIG. 1, the touch screen apparatus 1 includes a light-receiving section 110, a light guide section 120, a first light-emitting section 130, a second light-emitting section 140, and may further include a prism sheet (denoted by reference numeral 150 of FIG. 4), a diffuser (denoted by reference numeral 160 of FIG. 4), and the like.

The light-receiving section 110 is configured to sense lights emitted from the first light-emitting section 130 and the second light-emitting section 140. Preferably, the first light-emitting section 130 and the second light-emitting section 140 emit lights at different modulation frequencies.

That is, the first light-emitting section 130 is a light-emitting configuration provided to recognize an access extent and an access position of a hand in a state in which an object is not in contact with the touch screen apparatus 1. In related art, it is not possible to recognize an object when the object is not in contact with a touch screen apparatus because the touch screen apparatus 1 is configured to recognize the object only when the object is in contact therewith.

In this embodiment for solving this problem, the first light-emitting section 130 configured to sense an object and the second light-emitting section 140 configured to sense a touch by a finger are proposed. Since the first light-emitting section 130 is configured so that a position can be recognized before a touch is performed by a finger, it is possible to more accurately and rapidly recognize a position when the touch is performed by the finger.

It is effective for the first light-emitting section 130 and the second light-emitting section 140 to modulate lights at different frequencies and the light-receiving section 110 to recognize the lights by distinguishing the modulated lights, but the first light-emitting section 130 and the second light-emitting section 140 may be configured to emit infrared signals having different wavelength bands or sequentially emit light alternately.

If modulations are performed at different frequencies, an infrared light-emitting element having a peak value of, for example, about 950 nm, is used, and a light-receiving element capable of receiving the light is used. The infrared light to be emitted is modulated and processed. The light-receiving section 110 performs tuning and amplification, for example, at several tens of kHz suitable for the modulated infrared light. In the emitted infrared light, infrared light for sensing an object and infrared light for sensing a touch are modulated at separate frequencies. Preferably, the infrared light for sensing the object may be modulated at about 38 kHz, and the infrared light for sensing the touch may be modulated at about 58 kHz. The light-receiving section 110 performs tuning and amplification by distinguishing both of the frequency bands, and distinguishes simultaneously input infrared signals by a frequency difference. As necessary, it is possible to encode modulated light itself and allocate a specific command to the encoded modulated light so that the specific command can be executed.

On the other hand, if the first light-emitting section 130 and the second light-emitting section 140 emit lights of different wavelengths, the light-receiving section 110 may be constituted by two light-receiving groups that respectively receive light at each wavelength.

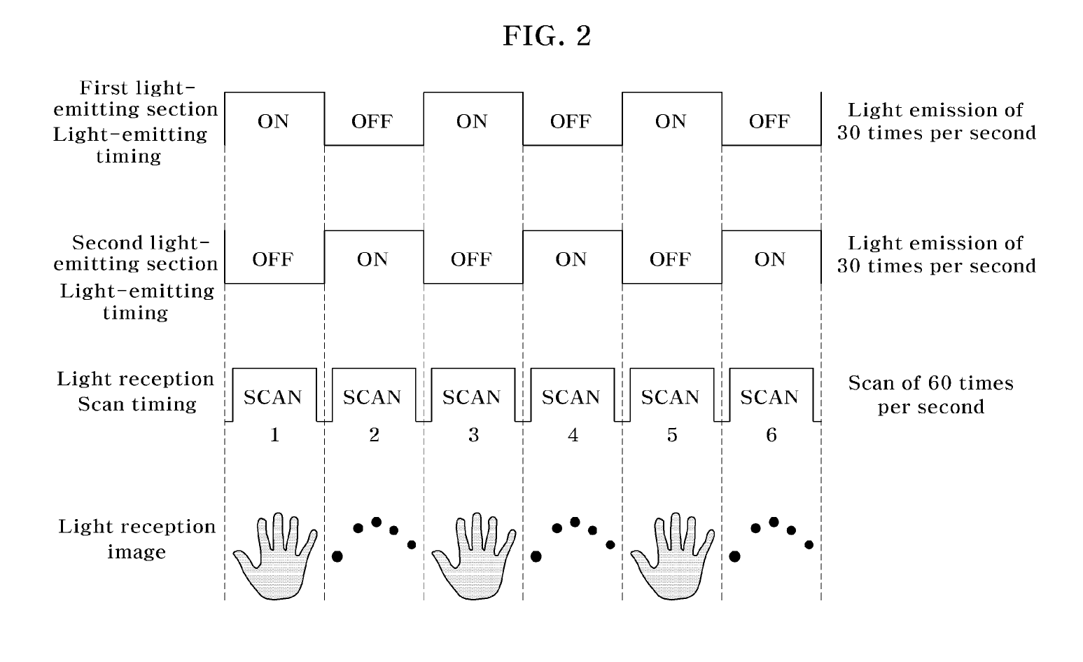

On the other hand, FIG. 2 is a conceptual diagram illustrating an example of a light-receiving mode and a light-emitting mode of the light-emitting sections 130 and 140 and the light-receiving section 110 applied to an embodiment of the present invention, and shows a method of causing the first light-emitting section 130 and the second light-emitting section 140 to sequentially emit light alternately.

That is, this is a method of receiving two signals without overlap upon light reception in the light-receiving section 110 by causing the first light-emitting section 130 and the second light-emitting section 140 to alternately emit light. Received data can be used to recognize a non-touch operation and a touch by separately dividing the received data into an image upon first light emission and an image upon second light emission.

Specifically, referring to FIG. 2, light-emitting times and orders of the first light-emitting section 130 and the second light-emitting section 140 differ according to a scan rate of the light-receiving section 110. For example, if the light-receiving section 110 receives light 60 times per second, the first light-emitting section 130 and the second light-emitting section 140 alternately emit light 30 times per second, respectively.

At this time, it is preferable to use a separate timing generation circuit so as to exactly synchronize ON/OFF of the first light-emitting section 130 and the second light-emitting section 140 and the scan of the light-receiving section 110. On the other hand, if a device such as a video camera or a webcam is used, it is possible to use a clock generation circuit embedded in the device for the light-receiving section 110.

To improve input sensitivity, a scan rate per second in the light-receiving section 110 may be increased to 120 or 180 times per second, or the like. In this case, ON/OFF of the first light-emitting section 130 and the second light-emitting section 140 is also increased in proportion thereto.

When general natural recognition of continuous actions during moving-image capturing is considered, it is preferable for the light-receiving section 110 to perform a scan operation 30 or more times per second. However, in the present invention, it is preferable to receive light 60 or more times per second in a method of performing a scan by dividing an image upon first light emission and an image upon second light emission according to a time difference.

If the first light-emitting section 130 and the second light-emitting section 140 alternately emit light as described above, any type of light can be used as long as light can be received by the light-receiving section 110, but it is preferable to use an infrared band to avoid interference from a visible ray.

In order to prevent interference from an external infrared component such as the sun, a remote control, or the like, it is possible to modulate light emission itself.

On the other hand, this touch screen apparatus acquires information in which light incident from the first light-emitting section 130 varies with access of an object to recognize an extent and coordinates of the access of the object using the acquired information, and acquires information in which light incident from the second light-emitting section 140 varies with contact of the object to recognize contact coordinates of the object using the acquired information.

That is, the light-receiving section 110 two-dimensionally includes unit light-receiving elements, for example, in the form of a matrix, and is configured to recognize an access position (X and Y coordinates) and an access extent of an object when the light-receiving section 110 receives light emitted by the first light-emitting section 130. It is possible to perform recognition using amounts of light received by the unit light-receiving elements.

The light guide section 120 performs a function of guiding and transferring light emitted from the second light-emitting section 140, and may be manufactured, for example, using an acrylic light guide plate or the like. The light guide section 120 may also perform a function of transferring light from the first light-emitting section 130.

The first light-emitting section 130 and the second light-emitting section 140 may be configured as a plurality of light-emitting elements disposed on one or two planes when viewed two-dimensionally.

Since the first light-emitting section 130 performs a function of distinguishing whether or not an object accesses the touch screen apparatus, the first light-emitting section 130 has a structure in which light is emitted at a fixed angle θ. It is preferable that θ be about 20 degrees to 80 degrees. An amount of light received by the light-receiving section 110 differs according to a position and an access extent of the object in terms of reflected light from the first light-emitting section 130 while the object accesses the touch screen apparatus 1.

For example, if the light-receiving section 110 is disposed in the form of a matrix when viewed two-dimensionally, an amount of light received by each light-receiving unit of the light-receiving section 110 varies with the position and the access extent of the object in terms of light emitted from the first light-emitting section 130. By sensing the variation, the X and Y position and the access extent of the object are determined.

In order to perform the above-described function, the light-receiving section 110 is connected to an external circuit section (not shown), and a position is recognized using an electric signal transferred from the light-receiving section 110. For this method, well-known technology may be used.

The light-receiving section 110 has a structure in which each light-receiving unit can receive light in the form of a matrix. The light-receiving section 110 can receive light emitted from the first light-emitting section 130 and the second light-emitting section 140 using one light-receiving unit. Also, light can be received by separating the light-receiving section 110 into a first light-receiving section and a second light-receiving section.

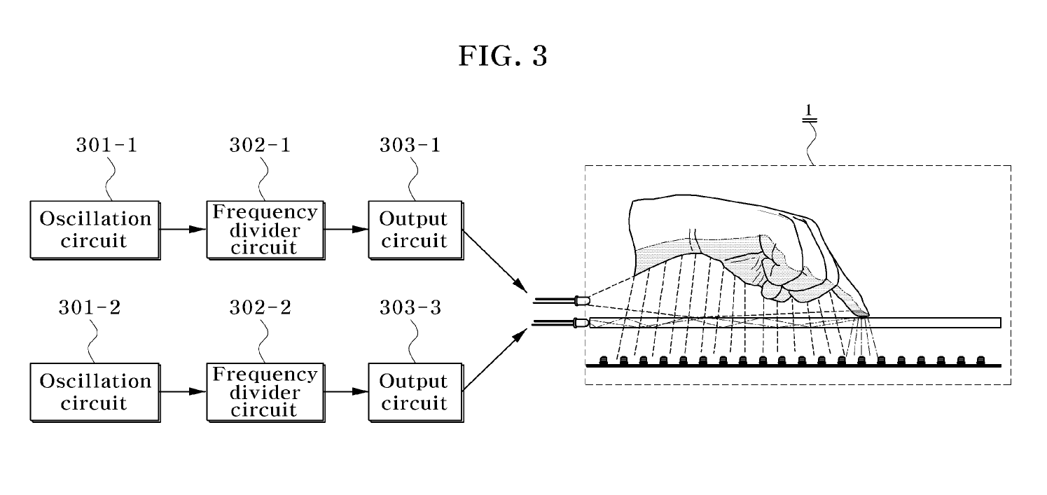

Next, an overall configuration including configurations of the light-emitting section and the light-receiving section of the present invention and its operation will be described in further detail with reference to FIGS. 3 and 4.

FIG. 3 is a detailed block diagram illustrating a detailed block diagram illustrating configurations of the light-emitting sections 130 and 140 according to an embodiment of the present invention in further detail, and FIG. 4 is a detailed block diagram illustrating a process of processing an optical signal received by a configuration of the light-receiving section 110 according to an embodiment of the present invention in further detail.

Referring to FIG. 3, first, oscillation circuits 301-1 and 301-2, frequency divider circuits 302-1 and 302-2, and output circuits 303-1 and 303-2 are included to emit light modulated by the light-emitting sections 130 and 140. For example, the oscillation circuits 301-1 and 301-2 perform an oscillation (ceramic oscillation) of about 455 kHz. An oscillated signal is divided by 12 or 8 through the frequency divider circuit 302-1 or 302-2. Accordingly, the frequency divider circuit 302-1 generates about 38 kHz by dividing 455 kHz by 12, and the frequency divider circuit 302-2 generates about 57 kHz by dividing 455 kHz by 8. Next, the output circuits 303-1 and 303-2 cause infrared light-emitting elements, for example, infrared LEDs, to emit light using about 0.3 A to 0.8 A.

By the above-described method, the first light-emitting section 130 and the second light-emitting section 140 can output modulated optical signals. However, FIG. 3 is only exemplary for understanding of the present invention.

FIG. 4 shows a simple configuration diagram for processing an optical signal received by the light-receiving section 110.

Referring to FIG. 4, an optical signal sensed through the light-receiving section 110 is converted into an electric signal, and a switching circuit 195 collects information sensed by each unit light-emitting element along with x and y axis information. On the other hand, since the light-receiving section 110 senses all differently modulated optical signals from both the first light-emitting section 130 and the second light-emitting section 140, it is necessary to separate the signals from each other. This operation is performed by a signal splitter 196. In the signal splitter 196, an amplifier 196a amplifies sensed signals. The amplified signals are respectively separated into a first bandpass filter 196b (for a 38 kHz band) and a second bandpass filter 196c (for a 57 kHz band).

On the other hand, the separated signals are respectively converted into digital signals through analog-to-digital (A/D) converters 197-1 and 197-2. After the signals are respectively converted into video signals through video signal conversion sections 198-1 and 198-2, an image processing section 199 performs image processing in real time.

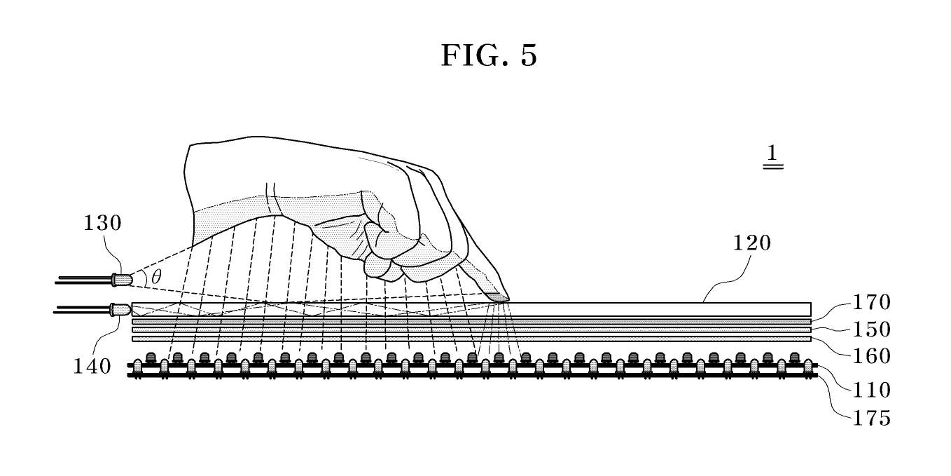

FIG. 5 is a schematic configuration diagram of a touch screen apparatus 1 according to another embodiment of the present invention.

Referring to FIG. 5, the touch screen apparatus 1 includes a light-receiving section 110, a light guide section 120, a first light-emitting section 130, and a second light-emitting section 140.

A structure in which a video panel 170 is additionally provided and a backlight 175 is integrated with the light-receiving section or is provided on another plate is different from the touch screen of FIG. 1.

For example, an LCD device including a thin-film transistor (TFT) substrate and a color filter substrate may be used as the video panel 170. If the LCD device is used, the backlight 175 for implementing a video is not an essential configuration. The backlight may be omitted in a reflection type of LCD device, when necessary. If an organic light emitting diode (OLED) device or the like is used as the video panel, the backlight itself is unnecessary. On the other hand, if the video panel 170 is added, it is preferable that the video panel 170 have a kind of permeability so that an optical signal varying with a touch or non-touch operation of an object is transferred to the light-receiving section 110 through the video panel 170. For this purpose, it is possible to add a configuration for securing permeability to the video panel 170.

A prism sheet 150, a diffuser 160, and the like may be further added.

The prism sheet 150 and the diffuser 160 are means for accurately transferring an optical signal varying with the touch or non-touch operation of the object to the light-receiving section 110, and use well-known functions.

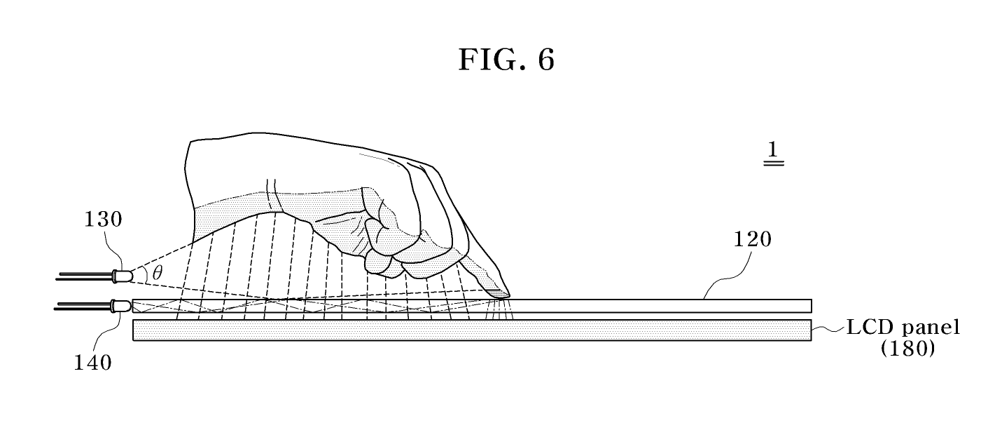

FIG. 6 is a schematic configuration diagram of a touch screen apparatus 1 according to yet another embodiment of the present invention.

Referring to FIG. 6, the touch screen apparatus 1 includes a light guide section 120, a first light-emitting section 130, and a second light-emitting section 140, and may further include a video panel 180. Here, a light-receiving section (denoted by reference numeral 110 of FIG. 1) is integrated inside the video panel 180.

An example in which the video panel 180 is an LCD device will be described. The LCD device is constituted by a TFT substrate and a color substrate. In the LCD device, a pin diode type of light-receiving element according to well-known technology may be embedded along with TFT switching elements manufactured in the form of a matrix within the TFT substrate. A pin diode is means for detecting an amount of light. Pin diodes arranged in the form of a matrix may perform a function of the light-receiving section (denoted by reference numeral 110 of FIG. 1). In this embodiment, an example of the LCD device has been described. Of course, the present invention can include all cases where the light-receiving section itself is embedded in the video panel.

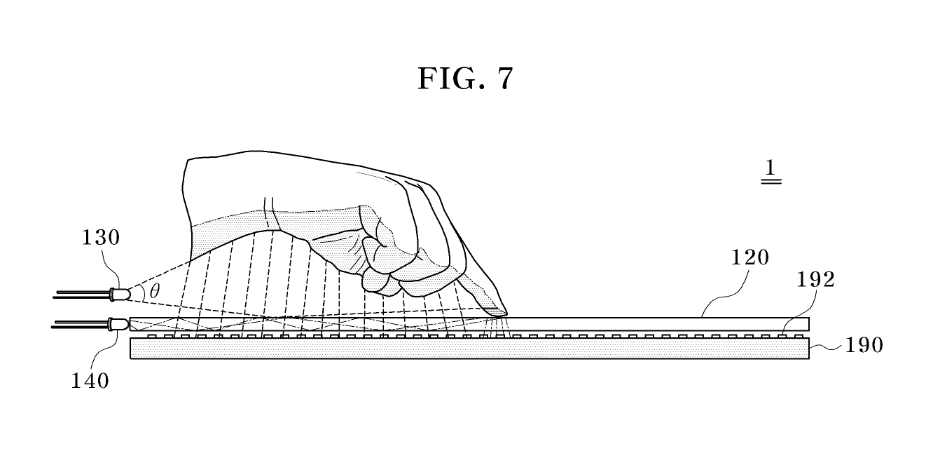

FIG. 7 is a schematic configuration diagram of a touch screen apparatus 1 according to yet another embodiment of the present invention.

Referring to FIG. 7, the touch screen apparatus 1 includes a light guide section 120, a first light-emitting section 130, a second light-emitting section 140, and a light-receiving element panel 190. A structure in which the light-receiving element panel 190 is provided is different from the touch screen of FIG. 1.

The light-receiving element panel 190 is a panel on which light-receiving elements 192 are disposed, for example, in the form of a matrix, and has semiconductor materials capable of receiving light on a transparent substrate. The light-receiving element panel 190 performs a function of transferring an electric signal of light received from the semiconductor materials to the outside through wirings. For example, it has a structure in which a p-n diode is formed using amorphous silicon on the transparent substrate formed of glass or plastic, and an electric signal generated by the formed p-n diode is transferred to the outside via the wirings.

The light-receiving element panel 190 provided adjacent to a lower portion of the light guide section 120 is shown in FIG. 7, but the light-receiving element panel 190 may be provided in various positions.

In a structure in which an LCD panel is added, the light-receiving element panel may be differently disposed according to a relationship with a backlight. First, if there is a backlight, the light-receiving element panel 190 may be disposed between the backlight and the light guide section, or may be disposed in a position where the light guide section is disposed (on an opposite side of a plane) after the backlight. In a structure having no backlight, it is preferable to provide the light-receiving element panel 190 to be adjacent to a lower portion of the light guide section 120.

For example, if light emitted from the backlight of the LCD device is transferred by passing through the light-receiving element panel 190 in a structure in which the light-receiving element panel 190 is added, light-receiving elements integrated within the light-receiving element panel 190 are affected by the light. It is possible to prevent the light-receiving elements from being affected by light of the backlight by forming a light shielding film on the light-receiving elements.

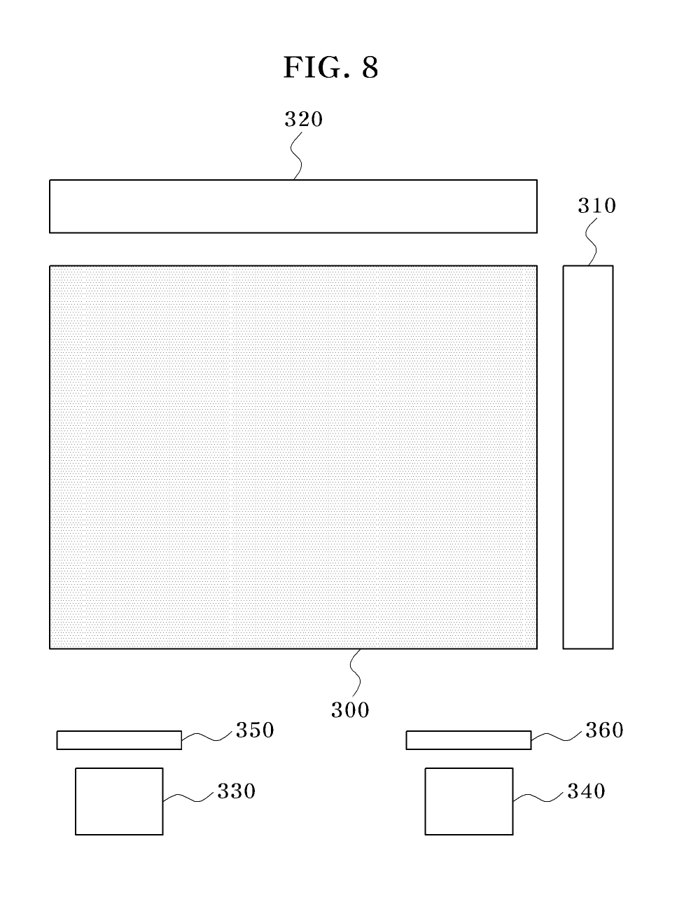

FIG. 8 is a schematic configuration diagram of a touch screen apparatus 1 according to yet another embodiment of the present invention.

Referring to FIG. 8, the touch screen apparatus 1 includes light-receiving sections 330 and 340, a light guide section 300, a first light-emitting section 310, and a second light-emitting section 320.

The light-receiving sections 330 and 340 are applicable in the form of an infrared sensing camera of a CCD, a CMOS image sensor, or the like. The first light-receiving section 330 and the second light-receiving section 340 are provided to sense lights of different wavelengths. It is effective for each of the first light-receiving section 330 and the second light-receiving section 340 to include a filter for specifying a wavelength region capable of being sensed by its own light-receiving section. For example, if the first light-receiving section 330 receives 800 nm light, it is preferable to provide filters 350 and 360 that pass 800 nm light in a front-end section of the first light-receiving section 330.

In this case, of course, the first light-emitting section 310 and the second light-emitting section 320 emit lights at different wavelengths. For example, if the first light-emitting section 310 emits an optical signal at 800 nm in wavelength and the second light-emitting section 320 emits an optical signal at 900 nm in wavelength, the first light-receiving section 330 can be configured to be suitable for reception of 800 nm light and the second light-receiving section 340 can be configured to be suitable for reception of 900 nm light.

Through this configuration, a touch screen can be implemented in both a touch type using the first light-emitting section 310 and a non-touch type using the second light-emitting section 320. Light emitted from the first light-emitting section 310 for touch sensing is guided by the light guide section 300 and is sensed by the first light-receiving section 330.

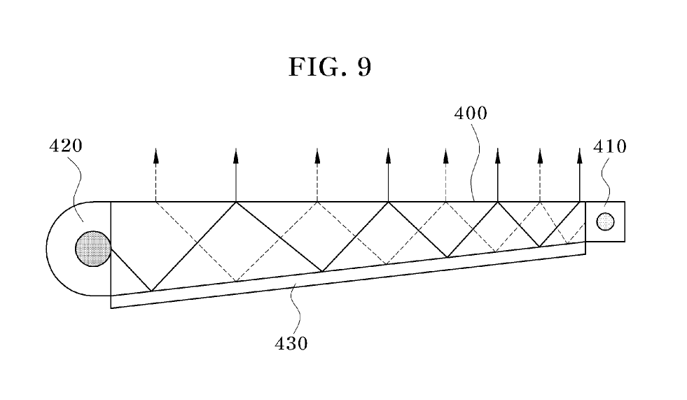

FIG. 9 is a schematic configuration diagram of a light-emitting section according to yet another embodiment of the present invention.

Referring to FIG. 9, the light-emitting section is integrated along with a backlight for an LCD device.

According to this embodiment, a light-emitting section 410 is provided at one end of a light guide plate 400 in a general backlight structure in which the light guide plate 400 and a light-emitting diode (LED) or cold cathode fluorescent light (CCFL) type of light source 420 are integrated together. For example, if a signal modulated at a fixed infrared frequency is emitted through the light-emitting section 410, the signal is guided by the light guide plate 400 and is emitted in an upward direction relatively uniformly in two dimensions. A reflection plate 430 is formed on a lower portion of the light guide plate 400.

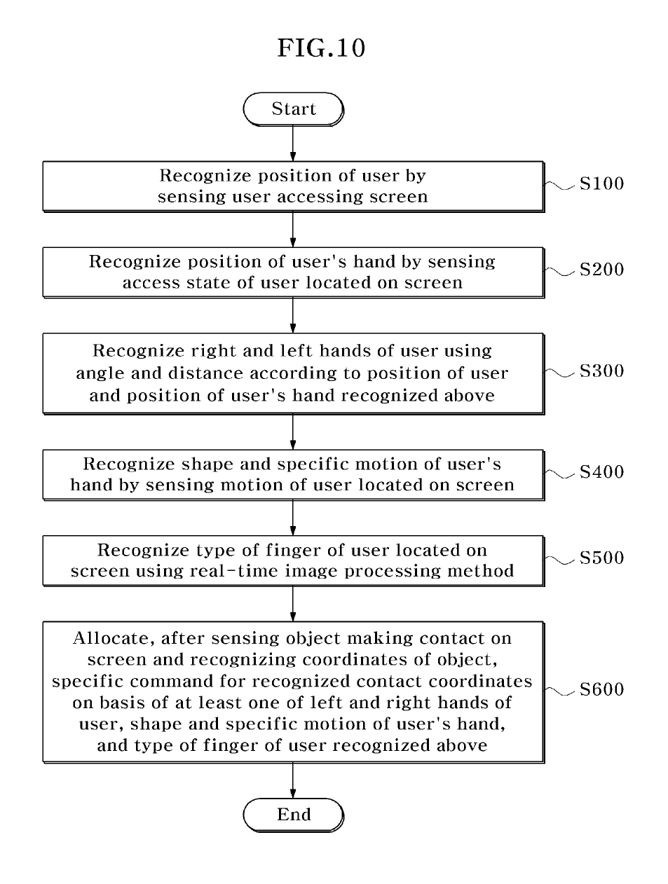

FIG. 10 is an overall flowchart illustrating a method for inputting user information on a screen through context awareness according to yet another embodiment of the present invention;

Referring to FIG. 10, first, user-specific recognition, that is, user-position recognition, is performed by sensing a user accessing the screen through a user recognition means provided inside/outside or around the screen (S100).

Here, the screen is a general display device, and can be implemented, for example, by an LCD, a field emission display (FED), a plasma display panel (PDP) device, an electro-luminescence (EL) display device, an OLED display device, a digital micro-mirror device (DMD) or a touch screen as well as a cathode ray tube (CRT) monitor.

The above-described user recognition means performs a function of individually sensing the user accessing a fixed region of the screen. It is preferable to install the user recognition means in all directions of the screen. For example, it is preferable to perform sensing using at least one camera or line sensor capable of performing tracking in real time.

It is preferable to implement the above-described camera by a general video camera or CCD camera capable of capturing a continuous video, a CCD camera having an image sensor such as a CCD line sensor and a lens, or the like, but the present invention is not limited thereto. The camera can be implemented by other cameras capable of capturing a continuous video to be developed in the future.

It is possible to use anything arranged to acquire one-dimensional information by sensing light such as ultraviolet light, visible light, or infrared light or an electromagnetic wave as the line sensor. For example, a photodiode array (PDA) or a photo film arranged in the form of a lattice may be used as the line sensor. Among these, the PDA is preferable.

On the other hand, when it is necessary to specify an individual user accessing the screen, sensing can be performed, for example, using RFID, a fingerprint recognition barcode, or the like.

Next, a position of the user's hand is recognized by sensing an access state of the user located on the screen, that is, an access state other than a direct touch, through an access state recognition means installed inside/outside or around the screen (S200).

At this time, the access state recognition means is used to sense the access state of the user located on the screen. For example, it is possible to perform sensing using any one of a camera, an infrared sensor, and a capacitive method as used in a general touch screen.

Thereafter, right and left hands of the user are recognized using an angle and a distance according to the position of the user and the position of the user's hand recognized in steps S100 and S200 (S300).

Next, a shape and a specific motion of the user's hand are recognized by sensing a motion of the user located on the screen through a motion recognition means installed inside/outside or around the screen (S400).

At this time, the motion recognition means is used to sense the user, that is, a motion of a hand, located on the screen and, for example, can perform sensing in the form of three-dimensional (X, Y, and Z) coordinates using a general CCD camera capable of capturing a continuous video, an infrared sensor, or the like.

On the other hand, a specific command can be allocated and executed on the basis of the shape and the specific motion of the user's hand recognized in step S400.

For example, if the user joins and opens the hands on the screen, a hidden command icon is displayed on the screen. A menu is differently output according to a height of the user's hand located on the screen (that is, it is possible to recognize a coordinate (Z) of a distance between the screen and an object).

Thereafter, a type of finger of the user located on the screen (for example, thumb, index, middle, ring, and little fingers of the left/right hand) is recognized using a real-time image processing method (S500).

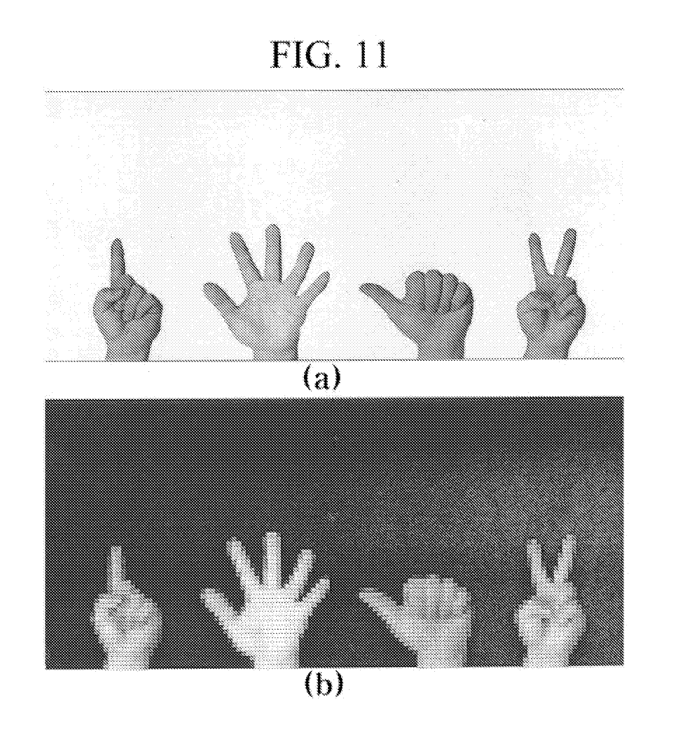

FIG. 11 is a diagram illustrating recognition of a finger shape of the user using real-time image processing applied to the method for inputting user information on the screen through context awareness according to yet another embodiment of the present invention. FIG. 11(a) shows hand shapes viewed on the screen, and FIG. 11(b) shows shapes converted into image data in a computer.

In general, the real-time image processing method can acquire an image of the user's hand located on the screen and then perform recognition by comparing the acquired hand image with various hand shape images previously stored.

Finally, after sensing an object making contact on the screen and recognizing coordinates of the object, a specific command is allocated for recognized contact coordinates on the basis of at least one of the left and right hands of the user, the shape and the specific motion of the user's hand, and the type of finger of the user recognized in steps S300 to S500. (S600). For example, an “A” command is allocated upon contact with the thumb, and a “B” command is allocated upon contact with the index finger.

It is possible to effectively prevent an erroneous operation caused by contact with a palm or the like by ignoring recognized contact coordinates other than those of fingers.

For example, an object making contact on the screen can be sensed using a camera, an infrared sensor, or a method in which multi-recognition is possible such as a capacitive method or the like.

On the other hand, it is preferable for a process of recognizing coordinates of a corresponding object by sensing the object making contact on the screen to be performed in parallel with steps S100 to S500.

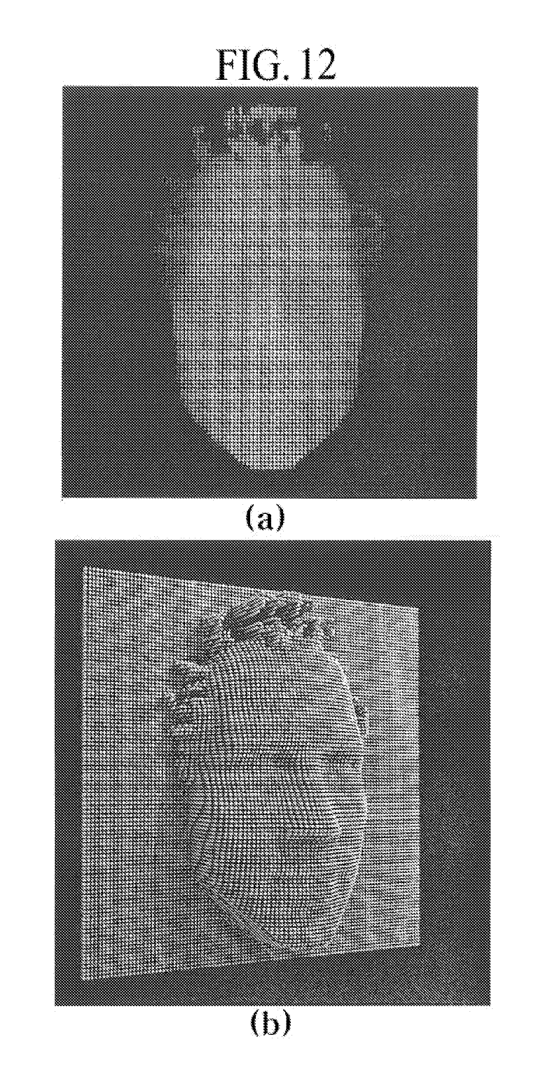

FIG. 12 is a diagram illustrating an example of a process of recognizing an object on the screen in the method for inputting user information on the screen through context awareness according to yet another embodiment of the present invention. After the brightness of an image is changed according to the strength of received infrared light as shown in FIG. 12(a), the brightness of each pixel is converted into a depth as shown in FIG. 12(b).

It is possible to implement a user information input device by including a user recognition means, an access state recognition means, a motion recognition means, an image processing means, a storage means, and the like as well as a general micro controller responsible for overall control using the method for inputting user information on the screen through context awareness according to yet another embodiment of the present invention.

The present invention is easily applicable to an interface or the like used in a touch screen or virtual reality, that is, a three-dimensional application, using the method for inputting user information on the screen through context awareness according to yet another embodiment of the present invention described above.

A method for inputting user information on a screen through context awareness according to the embodiment of the present invention may be implemented as computer-readable codes in computer-readable recording media. The computer-readable recording media include all kinds of recording devices in which data that is readable by a computer system is stored.

Examples of the computer-readable recording media include ROM, RAM, CD-ROM, a magnetic tape, a hard disk, a floppy disk, a removable storage device, a non-volatile memory (flash memory), an optical data storage device, or the like, and may also be implemented in the form of a carrier wave (for example, transmission through the Internet).

In addition, the computer-readable recording media may be distributed into the computer system connected through a computer communication network to store and implement the computer-readable codes in a distribution mechanism.

A touch screen apparatus and a method for inputting user information on a screen through context awareness according to the above-described preferred embodiments of the present invention have been described, but the present invention is not limited thereto. It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A touch screen apparatus comprising:
a first light-emitting section for emitting light of an optical signal to perform non-touch sensing;
a second light-emitting section for emitting light of an optical signal to perform touch sensing along with the non-touch sensing;
a light guide section for guiding the light emitted from the second light-emitting section; and
a light-receiving section for receiving the lights emitted from the first light-emitting section and the second light-emitting section varying with an object.

2. The touch screen apparatus of claim 1, wherein the first and second light-emitting sections emit the lights at different modulation frequencies.

3. The touch screen apparatus of claim 1, wherein the first and second light-emitting sections emit the lights of different wavelengths.

4. The touch screen apparatus of claim 1, wherein the light-receiving section is separated into a first light-receiving section and a second light-receiving section, which respectively sense different wavelengths.

5. The touch screen apparatus of claim 1, wherein the first and second light-emitting sections sequentially emit the lights alternately.

6. The touch screen apparatus of claim 5, wherein light-emitting times and orders of the first and second light-emitting sections differ according to a scan rate of the light-receiving section.

7. A touch screen apparatus comprising:
first and second light-emitting sections for emitting lights of optical signals to perform non-touch sensing and touch sensing; and
a light-receiving section for receiving the lights emitted from the first and second light-emitting sections varying with an object,
wherein the light-receiving section separates and senses the lights emitted from the first and second light-emitting sections.

8. The touch screen apparatus of claim 7, wherein the first and second light-emitting sections emit the lights by different modulations

9. The touch screen apparatus of claim 7, wherein the first and second light-emitting sections emit the lights of different wavelengths.

10. The touch screen apparatus of claim 7, wherein the first and second light-emitting sections sequentially emit the lights alternately by causing light-emitting times and orders to differ according to a scan rate of the light-receiving section.

11. A method for inputting user information on a screen through context awareness, comprising the steps of:
(a) recognizing a position of a user by sensing the user accessing the screen;
(b) recognizing a position of the user's hand by sensing an access state of the user located on the screen;
(c) recognizing right and left hands of the user using an angle and a distance according to the position of the user and the position of the user's hand recognized in steps (a) and (b);
(d) recognizing a shape and a specific motion of the user's hand by sensing a motion of the user located on the screen;
(e) recognizing a type of finger of the user located on the screen using a real-time image processing method; and
(f) allocating, after sensing an object making contact on the screen and recognizing coordinates of the object, a specific command for recognized contact coordinates on the basis of at least one of the left and right hands of the user, the shape and the specific motion of the user's hand, and the type of finger of the user recognized in steps (c) to (e).

12. The method of claim 11, wherein, in step (a), the user accessing the screen is sensed using at least one camera or line sensor installed in all directions of the screen.

13. The method of claim 11, wherein, in step (d), a specific command is allocated and executed on the basis of the recognized shape and specific motion of the user's hand.

14. The method of claim 11, wherein, in step (d), the shape and the specific motion of the user's hand located on the screen are recognized in real time using three-dimensional (X, Y, and Z) coordinates.

15. The method of claim 11, wherein, in step (e), the real-time image processing method acquires an image of the user's hand located on the screen and performs recognition by comparing the acquired hand image with various hand shape images previously stored.

16. A method for inputting user information on a screen through context awareness, comprising the steps of:
(a′) recognizing a shape and a specific motion of a user's hand by sensing a motion of the user located on the screen; and
(b′) allocating a specific command on the basis of the recognized shape and specific motion of the user's hand.

17. The method of claim 16, wherein, in step (a′), the shape and the specific motion of the user's hand located on the screen are recognized in real time using three-dimensional (X, Y, and Z) coordinates.
